(19) United States
(12) Patent Application Publication
(10) Pub. No.: US 2008/0163572 A1
(43) Pub. Date: Jul. 10, 2008

(54) DECORATIVE GRID SYSTEM AND METHOD

(76) Inventors: David Eugene Lee, Avondale Estates, GA (US); Matthew David Kennedy, Roswell, GA (US)

Correspondence Address: GEORGE R. REARDON, 3356 STATION COURT, LAWRENCVILLE, GA, 30044, US

(21) Appl. No.: 12/051,010

(22) Filed: Mar. 19, 2008

Related U.S. Application Data
(63) Continuation-in-part of application No. 11/338,357, filed on Jan. 24, 2006.

(51) Int. Cl. E06B 3/66; E06B 3/663; E04B 1/12

(52) U.S. Cl. 52/204.61; 52/786.13; 52/745.19

(57) ABSTRACT

A window muntin apparatus and system, and methods for forming the same is disclosed. The muntins are formed from a substrate of expanded cellular polyvinyl chloride (“PVC”) that has been applied with a desired muntin shape and machined by a computerized numerically controlled (CNC) machine such as a 3-axis router. Muntins are then sealed between two pieces of glass to create a sealed insulated glass unit.

This application claims the benefit of the filing date of and is a continuation-in-part of United States Utility Patent Application having a title of DECORATIVE GRID SYSTEM AND METHOD, filed on Jan. 24, 2006 and assigned Ser. No. 11/338,357.

### FIELD OF THE INVENTION

The technology described herein relates generally to the field windows and more particularly to a decorative grid and muntin system and method.

### BACKGROUND OF THE INVENTION

Muntins are typically used in many types of windows in order to provide decoration for both insulated glass also known as Grill-Between-Glass (“GBG”) and Simulated Divided Lite (“SDL”) windows. Insulated glass (IG) windows are known as multiple panes of glass, typically two panes, being spaced thereby creating an air space between the panes. The panes are sealed, thereby becoming what is considered a single pane of glass having an insulating air space. GBG windows are advantageous because the insulating barrier between the panes results in energy conservation. Prior to sealing the two panes together, muntins are often placed between the panes to provide decoration.

Typical muntins are metal, plastic or wood. Regardless of the type of material, muntins present several problems in the GBG windows. For example, excessive heating and exposure to sunlight cause the muntins to warp and discolor causing a permanent unaesthetic appearance of the GBG window. Furthermore, the heat and light causes outgassing of the muntins, which is the release of moisture, liquid and/or chemical gases from the material.

The outgassing causes the moisture to be retained between the panes resulting in permanent clouding on the panes of glass that cannot be removed. For several of the materials used in present muntins, expensive and prolonged treatment, such as painting and heat curing, is required before placement of the muntins between the panes of glass. Muntins can also be used on SDL glass to give the appearance of True Divided Lite (“TDL”) windows, which are typically more difficult and time consuming to manufacture. The use of muntins for SDL windows can also cause similar problems associated with GBG window muntins, such as warping and discoloring, often cause by heat, sunlight and local outgassing.

These and other problems exist. Previous attempts to solve these and other problems include U.S. Pat. No. 7,318,301.

The foregoing patent reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In general, the technology described herein features a decorative (muntin) system and method. The muntins are formed from a substrate of expanded cellular polyvinyl chloride (“PVC”) material that has been applied with a desired muntin shape and machined by a computerized numerically controlled (CNC) machine.

In general, in one aspect, the technology described herein features a window system, including a pane of glass and a window muntin located adjacent the pane of glass, wherein the window muntin is formed from a substrate of expanded cellular polyvinyl chloride (“PVC”) material.

In one implementation, the substrate of expanded cellular polyvinyl chloride material is ultraviolet (UV) resistive.

In another implementation, the pane of glass and the muntin are adhered together as an SDL application.

In another implementation, the system further includes a second pane of glass generally parallel to the pane of glass, the muntin being located therebetween.

In another implementation, the system further includes a spacer connected along outer edges of the panes of glass and the muntin.

In another implementation, the panes of glass and the muntin are connected together in a GBG configuration.

In another aspect, the technology described herein features a method of manufacturing a window muntin, including creating a design of the window muntin, forming a substrate of expanded cellular polyvinyl chloride (“PVC”) material, forming the design of the window muntin on the substrate of the expanded cellular polyvinyl chloride (“PVC”) material and cutting the design of the window muntin from the substrate of the expanded cellular polyvinyl chloride (“PVC”) material.

In another aspect, the technology described herein features an improved window muntin being positioned between two panes of glass and sealed there-between, wherein the improvement comprises means for eliminating the outgassing and UV deterioration of the muntin.

In another implementation, the technology described herein features an improved method of forming a window of the type having two panes of glass having a space defined therebetween, the spaces being sealed from external environmental conditions, the improvement comprising forming a muntin for placement within the airspace prior to sealing the airspace, the muntin being formed by a substrate of expanded cellular polyvinyl chloride (“PVC”) material.

In another aspect, the technology described herein features a window muntin made by the process, including forming a planar sheet from a substrate of expanded cellular polyvinyl chloride (“PVC”) material, forming a decorative grid design on the planar sheet and cutting out the decorative grid design with a computerized numerically controlled (CNC) machine to form the muntin.

In one implementation, the process further includes optionally smoothing rough portions from the muntin and optionally finishing the muntin with at least one of paint and stain, and optionally air dried.

In another implementation, the process further includes placing the muntin in a Grill-Between-Glass (GBG) configuration.

In another implementation, the process further includes placing the muntin in a Simulated Divided Lite (SDL) configuration.

One advantage of the technology described herein is that it provides a muntin that does not degrade or warp.

Another advantage of the technology described herein is that it provides a muntin that does not yellow, fade or otherwise discolor.

Another advantage of the technology described herein is that it provides a muntin that does not require heat curing during production.

Another advantage of the technology described herein is that it provides a muntin that does not offgas.

Another advantage of the technology described herein is that it provides a muntin that does not contribute to moisture sealed between double pane windows.

Another advantage of the technology described herein is that it provides a muntin that does not absorb moisture.

Another advantage of the technology described herein is that it provides a muntin that can be painted or otherwise coated or not and air dried.

Another advantage of the technology described herein is that it can easily be beveled, textured or otherwise shaped.

Another advantage of the technology described herein is that a unitary one piece window muntin can be manufactured.

Another advantage of the technology described herein is that the methods described herein can be used to form window muntins as well as muntins for doors and other shaped windows.

There are additional features of the technology that will be described hereinafter and which will form the subject matter of the claims appended hereto. In this respect, before explaining at least one embodiment of the technology in detail, it is to be understood that the technology described herein is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

Other objects, advantages and capabilities of the technology described herein are apparent from the following description taken in conjunction with the accompanying drawings showing the preferred embodiment of the invention.

### BRIEF DESCRIPTION OF THE DRAWINGS

The technology described herein is illustrated with reference to the various drawings, in which like reference numbers denote like system components and/or method steps, respectively, and in which:

FIG. 1 illustrates an embodiment of a window muntin 100 formed of expanded cellular polyvinyl chloride (“PVC”) material and shaped into a desired configuration;

FIG. 2A & FIG. 2B illustrate two embodiments of muntin retaining pins;

FIG. 3 illustrates an end view of an embodiment of the muntin as illustrated in FIG. 1 showing holes drilled into ends; and

FIG. 4 illustrates an embodiment of a GBG window system.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

The embodiments described herein can be used for a large variety of muntin types, including but not limited to GBG and SDL windows. Regardless of the type of window, the muntin is typically formed by creating a desired muntin pattern on a substrate or board of expanded cellular polyvinyl chloride (“PVC”). The desired pattern is then cut from the board, typically using a CNC overhead router previously drawn on a CAD program. In a typical embodiment, the board used to form the muntins from the computerized numerically controlled (CNC) overhead router is 5′×10′. In addition, the board can generally have a thickness of 0.238-1.27 cm, and having typical thickness of, including but not limited to 0.318, 0.635 and 0.953 cm.

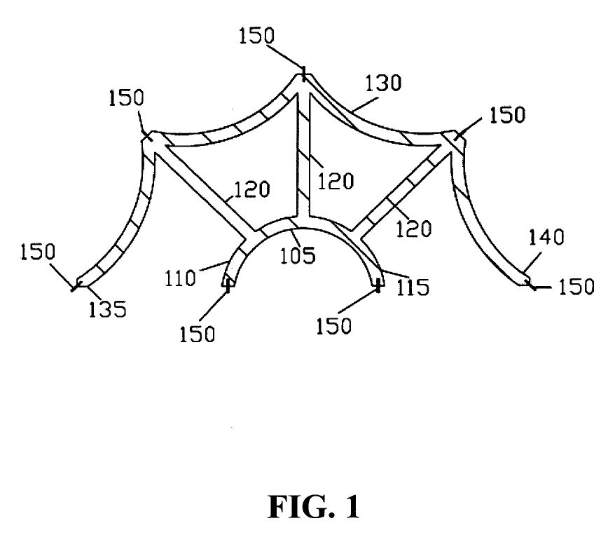

Typical muntins have a larger variety of shapes and sizes. FIG. 1 illustrates an embodiment of a window muntin 100 formed of expanded cellular polyvinyl chloride (“PVC”) and shaped into a desired configuration. In the embodiment, the muntin 100 has a semi-circular inner rim 105 having terminal ends 110, 115 and three protruding bars 120 connected generally along the circumference of the inner rim 105. A patterned outer rim 130 is connected to the ends of the bars 120, the outer rim 130 being generally concentric with the semi-circular inner rim 105. The outer rim 130 typically includes terminal ends 135, 140. It is appreciated that the rims 105, 130 and bars 120 are typically an integral piece formed and cut from the expanded cellular polyvinyl chloride (“PVC”), and share a common plane of orientation.

After the cutting machine has cut out the muntin 100, the muntin 100 is typically checked for smoothness. If desired, the muntin 100 can be sanded, typically with fine grit sandpaper and then cleaned. When a desired texture is achieved the muntin 100 is optionally painted or stained. When the paint has cured, the muntin 100 can be further processed, the processing depending on the muntin 100 types. For grid between glass (GBG) muntins, as shown with muntin 100 in FIG. 1, a 0.159 cm ( 1/16 inch) wide hole is typically drilled into the ends of the bars 120, and the terminal ends 110, 115 of the inner rim 105 and the terminal ends 135, 140, of the outer rim 130. The holes are drilled parallel to the plane of orientation, to a depth generally ranging from about 0.841 to 1.27 cm. It is understood that a variety of depths are possible depending on the application. A retaining pin 150 is used to connect the muntin 100 to its final position between panes of glass typically to a spacer as described further below, directly into a frame or into other orientation.

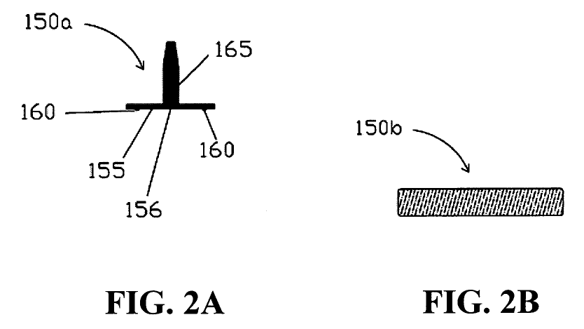

FIG. 2A and FIG. 2B illustrate two embodiments 150a, 150b of retaining pins 150 as just described. In one embodiment, the retaining pin 150a is a pin having a generally planar head 155, which can be square or rectangular, and a shaft 165 having a depth suitable to fit into holes drilled into the ends 110, 115, 135, 140 as described above. The shaft 165 can further be advantageously tapered at the end in order to provide ease of insertion into the holes and thicker toward the head 155 to provide a snug fit. The head 155 can further include one or more dimples 160 positioned along an upper surface 156 of the head 155, the dimples 160 generally providing a frictional fit when placed adjacent a spacer as described further below.

In another embodiment, the retaining pin 150b is an elongated cylindrical shaft having tapered ends for affixation into the holes of the ends 110, 115, 135, 140 as described above and for insertion into holes provided on window frames when fit directly into structures.

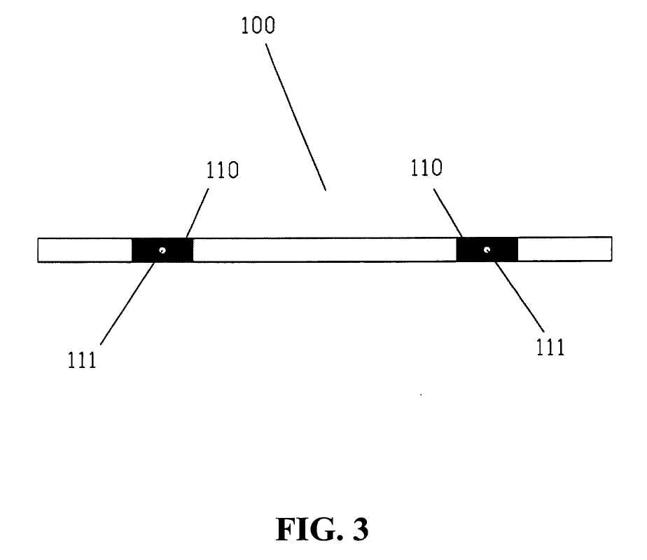

FIG. 3 illustrates an end view of an embodiment of the muntin 100 as illustrated in FIG. 1 showing holes 111 drilled into ends 110, 115.

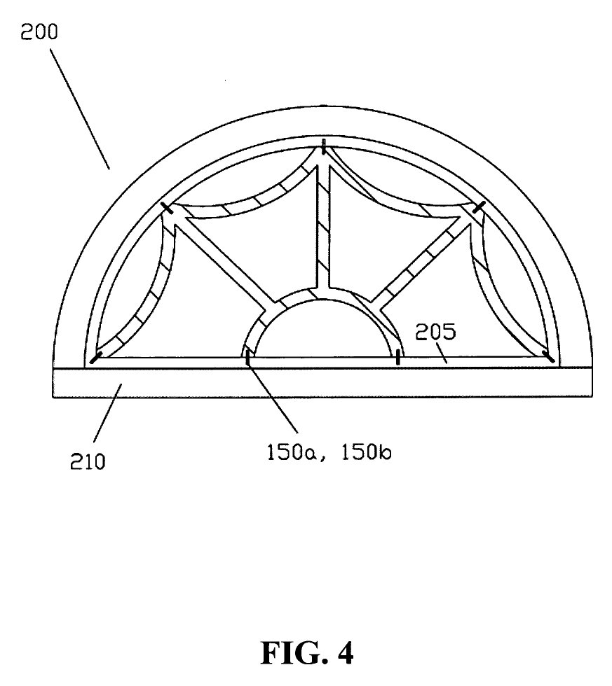

FIG. 4 illustrates an embodiment of a GBG window system 200. The system 200 includes an embodiment of a muntin 100 as described above. The muntin 100 is connected to a spacer 205 that is connected to a window frame 210. As described above, either embodiment of the connector pins 150a, 150b can be used to connect the muntin 100 to the spacer 205.

In another implementation, the muntin 100 can be formed as described for GBG use, but be modified for SDL use. For SDL muntins, no holes are typically drilled into the ends 110, 115, 135, 140. Instead, one side of the SDL muntin is wiped clean providing a clean, smooth and dry surface onto which adhesive, such as two-sided tape can be affixed for subsequent attachment to glass for an SDL window.

In one embodiment the technology described herein is a window system, comprising: a first pane of glass; a second pane of glass generally parallel to the first pane of glass; a window muntin located therebetween the first pane of glass and the second pane of glass, where the window muntin is formed from a substrate of UV resistive expanded cellular polyvinyl chloride (“PVC”) material, and the first pane of glass, the second pane of glass and the window muntin are adhered together as a Simulated Divided Lite (“SDL”) configuration; and a spacer disposed along outer edges of the panes of glass and the muntin.

In another embodiment the technology described herein is a window system, comprising: a pane of glass; and a window muntin located proximate the pane of glass, where the window muntin is formed from a substrate of expanded cellular polyvinyl chloride (“PVC”) material. In this window system the pane of glass and the window muntin are adhered together as a Simulated Divided Lite (“SDL”) configuration.

In another embodiment the technology described herein is a window system, comprising: a pane of glass; and a window muntin located proximate the pane of glass, where the window muntin is formed from a substrate of expanded cellular polyvinyl chloride (“PVC”) material. This window system is further comprised of a second pane of glass generally parallel to the pane of glass, the muntin being located therebetween; it is furthermore comprised of a spacer disposed along outer edges of the panes of glass and the muntin. In one implementation the panes of glass and the muntin are connected together in a GBG configuration and are further comprised of means for eliminating outgassing and UV deterioration of the muntin.

The technology described herein includes a method of manufacturing a window muntin, the method comprising: creating a design of the window muntin; forming a substrate of expanded cellular polyvinyl chloride (“PVC”); forming the design of the window muntin on the substrate of expanded cellular polyvinyl chloride (“PVC”) material; and cutting the design of the window muntin from the substrate of the expanded cellular polyvinyl chloride (“PVC”) material.

The technology described herein includes an improved method of forming a window having two panes of glass having an airspace defined therebetween, the airspace being sealed from external environmental conditions, the improvement comprising forming a muntin for placement within the airspace prior to sealing the airspace, the muntin being formed from a substrate of expanded cellular polyvinyl chloride (“PVC”) material.

The technology described herein includes a window muntin made by the process, comprising: forming a planar sheet from a substrate of expanded cellular polyvinyl chloride (“PVC”) material; programming a CNC machine to form a decorative grid design on the planar sheet; and cutting out the decorative grid design with a CNC machine to form the muntin. This process further comprises: optionally smoothing rough portions from the muntin; and optionally finishing the muntin with a coating chosen from the group consisting of paint and stain. This process further comprises placing the muntin in a Grill-Between-Glass (“GBG”) configuration or placing the muntin in a Simulated Divided Lite (“SDL”) configuration.

The foregoing description and drawings comprise illustrative embodiments of the technology described herein. Having thus described exemplary embodiments of the technology described herein, it should be noted by those skilled in the art that the within disclosures are exemplary only, and that various other alternatives, adaptations, and modifications may be made within the scope of a method in a certain order does not constitute and limitation on the order of the steps of the method. Merely listing or numbering the steps of a method in a certain order does not constitute any limitation on the order of the steps of that method. Many modifications and other embodiments of the technology described herein will come to mind to one skilled in the art to which this technology described herein pertains having the benefit of the teachings presented in the foregoing descriptions and the associated drawings. Although specific terms may be employed herein, they are used in a generic and descriptive sense only and not for purposes of limitation. Accordingly, the technology described herein is not limited to the specific embodiments illustrated herein, but is limited only by the following claims.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A window system, comprising:
a first pane of glass;
a second pane of glass generally parallel to the first pane of glass;
a window muntin located therebetween the first pane of glass and the second pane of glass, wherein the window muntin is formed from a substrate of UV resistive expanded cellular polyvinyl chloride (“PVC”) material, and the first pane of glass, the second pane of glass and the window muntin are adhered together as a Simulated Divided Lite (“SDL”) configuration; and
a spacer disposed along outer edges of the panes of glass and the muntin.

2. A window system, comprising:
a pane of glass; and
a window muntin located proximate the pane of glass,
wherein the window muntin is formed from a substrate of expanded cellular polyvinyl chloride (“PVC”) material.

3. The system as claimed in claim 2, wherein the pane of glass and the window muntin are adhered together as a Simulated Divided Lite (“SDL”) configuration.

4. The system as claimed in claim 2, further comprising a second pane of glass generally parallel to the pane of glass, the muntin being located therebetween.

5. The system as claimed in claim 4 further comprising a spacer disposed along outer edges of the panes of glass and the muntin.

6. The system as claimed in claim 4 wherein the panes of glass and the muntin are connected together in a GBG configuration.

7. The system as claimed in claim 6, further comprising means for eliminating outgassing and UV deterioration of the muntin.

8. A method of manufacturing a window muntin, the method comprising:
creating a design of the window muntin;
forming a substrate of expanded cellular polyvinyl chloride (“PVC”);
forming the design of the window muntin on the substrate of expanded cellular polyvinyl chloride (“PVC”) material; and
cutting the design of the window muntin from the substrate of the expanded cellular polyvinyl chloride (“PVC”) material.

9. An improved method of forming a window having two panes of glass having an airspace defined therebetween, the airspace being sealed from external environmental conditions, the improvement comprising forming a muntin for placement within the airspace prior to sealing the airspace, the muntin being formed from a substrate of expanded cellular polyvinyl chloride (“PVC”) material.

10. A window muntin made by the process, comprising:
forming a planar sheet from a substrate of expanded cellular polyvinyl chloride (“PVC”) material;
programming a CNC machine to form a decorative grid design on the planar sheet; and
cutting out the decorative grid design with a CNC machine to form the muntin.

11. The process as claimed in claim 10, further comprising:
optionally smoothing rough portions from the muntin; and
optionally finishing the muntin with a coating chosen from the group consisting of paint and stain.

12. The process as claimed in claim 11 further comprising placing the muntin in a Grill-Between-Glass (“GBG”) configuration.

13. The process as claimed in claim 11 further comprising placing the muntin in a Simulated Divided Lite (“SDL”) configuration.
